(19) United States
(12) Patent Application Publication
(10) Pub. No.: US 2014/0188945 A1
(43) Pub. Date: Jul. 3, 2014

(54) ADDING TLD REGISTRATION CAPABILITIES TO A REGISTERING ENTITY

(71) Applicant: GO DADDY OPERATING COMPANY, LLC, Scottsdale, AZ (US)

(72) Inventors: Jeremy Bushlack, Marion, IA (US); Richard Merdinger, Coralville, IA (US); Jody Kolker, Mount Vernon, IA (US); Alex Passos, Marion, IA (US); Joe Snitker, Marion, IA (US)

(73) Assignee: GO DADDY OPERATING COMPANY, LLC, Scottsdale, AZ (US)

(21) Appl. No.: 13/731,874

(22) Filed: Dec. 31, 2012

(51) Int. Cl. G06F 17/30

(52) U.S. Cl. CPC G06F 17/30292
USPC 707/805

(57) ABSTRACT

Domain name Registrars typically offer for registration domain names that have a variety of different Top-level Domains (TLDs). Each TLD may have different business requirements (rules the Registrar follows when registering a domain name having the TLD). A Registrar must reconfigure its functions when the Registrar wants to offer a new TLD or when business rules change for a TLD already being offered by the Registrar. The present invention allows the Registrar to easily reconfigure its functions to accept new business rules by storing the business rules in an electronic document stored in a database. The electronic document is preferably written in a TLD markup language (TLDML).

### CROSS REFERENCE TO RELATED PATENT APPLICATIONS

This patent application is related to U.S. patent application Ser. No. ______ titled: “A TLD MARKUP LANGUAGE” concurrently filed herewith and also assigned to Go Daddy Operating Company, LLC.

This patent application is related to U.S. patent application Ser. No. ______: “A TLD MARKUP LANGUAGE BASED DOMAIN NAME REGISTERING ENTITY” concurrently filed herewith and also assigned to Go Daddy Operating Company, LLC.

This patent application is related to U.S. patent application Ser. No. ______ titled: “CREATING AND USING A TLD MARKUP LANGUAGE” concurrently filed herewith and also assigned to Go Daddy Operating Company, LLC.

### FIELD OF THE INVENTION

The present inventions generally relate to adding the capability to register a new top-level domain (TLD) at a Registrar.

### SUMMARY OF THE INVENTION

The systems and methods disclosed herein provide for programmatically configuring a Registrar when the Registrar desires to register domain names having a new (at least for the Registrar) top-level domain (TLD) or when the business requirements for a TLD already offered by the Registrar change.

An exemplary system may include a database storing a plurality of electronic documents. Each electronic document may contain a plurality of business requirements for one, and only one, TLD and no two electronic documents contain business requirements for the same TLD.

Another exemplary system may include an electronic document database storing a plurality of electronic documents. Each electronic document may contain a plurality of business requirements for a single TLD. An interface may be in communication with a plurality of users over a computer network. The interface may be configured to accept a new plurality of business requirements for a new TLD from one of the plurality of users. A software program running on a server may programmatically transform the new plurality of business requirements for the new TLD into a new electronic document. The software program may store the new electronic document in the electronic document database.

Another exemplary system may include an electronic document database storing a plurality of electronic documents. Each electronic document, in the plurality of electronic documents, may contain business requirements for a single TLD. A user interface may be in communication with the electronic document database. The user interface may be configured to: 1) read an electronic document from the plurality of electronic documents, 2) allow the electronic document to be modified, and 3) store the modified electronic document in the electronic document database.

Another exemplary system may include an electronic document database storing a plurality of electronic documents. Each electronic document, in the plurality of electronic documents, may contain business requirements for a single TLD and no two electronic documents contain business requirements for the same TLD. A user interface may be in communication with the electronic document database. The user interface may be configured to: 1) accept a plurality of new business requirements for a new TLD, 2) create a new electronic document that includes the plurality of new business requirements for the new TLD, and 3) store the new electronic document in the electronic document database.

Another exemplary system may include an electronic document database storing a plurality of electronic documents. Each electronic document may contain business requirements for a single TLD. A plurality of functions within a domain name registering entity may be in communication with the electronic document database. A first function within the plurality of functions may be in communication with a first function database and a second function within the plurality of functions may be in communication with a second function database.

Another exemplary system may include an electronic document database storing a plurality of electronic documents. Each electronic document may contain business requirements for one, and only one, TLD within a plurality of TLDs. A front of site software function may be in communication with the electronic document database. A website may be configured by the front of site software function to offer for registration domain names having a TLD within the plurality of TLDs.

Another exemplary system may include an electronic document database storing a plurality of electronic documents. Each electronic document may contain business requirements for a single TLD within a plurality of different TLDs. A plurality of web services may be in communication with the electronic document database. A website may be configured by the plurality of web services to offer for registration domain names having the plurality of different TLDs.

An exemplary method may start by creating a structured markup language. An electronic document may be written in the structured markup language that describes a plurality of business requirements for a TLD. The electronic document may be used to configure a system to register a plurality of domain names having the TLD. The system may receive a registration request from a Registrant for a domain name having the TLD and the system may register the domain name to the Registrant.

Another exemplary method may start by gathering a plurality of business requirements specific to a TLD. The TLD business requirements may be recorded in a structured markup language document. The plurality of TLD business requirements specific to the TLD in the structured markup language document may be used to configure a domain name registration system to offer for registration domain names having the TLD.

Another exemplary method may start by creating an electronic record that includes a plurality of business requirements for a TLD. The electronic record may be stored in a database and communicated to a plurality of functions within a domain name registration system. The plurality of functions may configure the domain name registration system to offer for registration domain names having the TLD.

Another exemplary method may start by storing an electronic document in a database. The electronic document may describe a plurality of TLD business requirements and be written in a structured markup language. A first software routine may receive some of the plurality of business requirements from the electronic document. The first software routine may then configure a first function within a domain name registering entity to permit the domain name registering entity to register a plurality of domain names having the TLD.

Another exemplary method may start by storing an electronic document, written in a structured markup language, in a database of a domain name registering entity. The electronic document may describe a plurality of TLD business requirements. A first function within the domain name registering entity may read the electronic document from the database, parse the electronic document for one or more of the plurality of TLD business requirements, and configure a first part of the domain name registering entity to permit the domain name registering entity to register a plurality of domain names having the TLD.

Another exemplary method may start by providing a computer interface that permits a user to select a TLD from a plurality of TLDs. The system may receive a plurality of structured markup language fragments for the selected TLD from a plurality of functions within a domain name registering entity. The plurality of structured markup language fragments may be merged (repeated sections may be ignored and incompatible sections may be flagged) into an electronic document that is displayed on the computer interface.

The above features and advantages of the present inventions will be better understood from the following detailed description taken in conjunction with the accompanying drawings.

### BRIEF DESCRIPTION OF THE DRAWINGS

FIG. 1 illustrates a possible embodiment of an enhanced domain name registration system with a user interface and a database.

FIG. 2 illustrates a possible embodiment of an enhanced domain name registration system with a server between the user interface and the database.

FIG. 3 illustrates a possible embodiment of an enhanced domain name registration system with a first function and a first database and a second function and a second database.

FIG. 4 illustrates a possible embodiment of an enhanced domain name registration system with a website and a front of site software function.

FIG. 5 illustrates a possible embodiment of an enhanced domain name registration system with multiple different web services with corresponding application specific implementations (functions), a user interface web site, a TLDML merge component and a reverse TLDML function.

FIG. 6 illustrates a possible embodiment of an enhanced domain name registration system with multiple functions having their own databases and a middle tier and an application stack.

FIG. 7 illustrates a possible embodiment of a Registrar/domains implementation section of an enhanced domain name registration system.

FIG. 8 illustrates a possible embodiment of an E-commerce implementation section of an enhanced domain name registration system.

FIG. 9 illustrates a possible embodiment of a front of site (FOS) implementation section of an enhanced domain name registration system.

FIG. 10 is a flow diagram illustrating a possible embodiment of a method for configuring a system to register domain names having a TLD.

FIG. 11 is a flow diagram illustrating a possible embodiment of a method for configuring a system to register domain names having multiple TLDs.

FIG. 12 is a flow diagram illustrating a possible embodiment of a method for reconfiguring a system to register domain names having a TLD.

FIG. 13 is a flow diagram illustrating a possible embodiment of a method for configuring a system to register domain names having a TLD.

FIG. 14 is a flow diagram illustrating a possible embodiment of a method for configuring a system to register domain names having a TLD and then reconfiguring the system if the business requirements for the TLD change.

FIG. 15 is a flow diagram illustrating a possible embodiment of a method for configuring a first function within a domain name registering system.

FIG. 16 is a flow diagram illustrating a possible embodiment of a method for configuring multiple functions within a domain name registering system.

FIG. 17 is a flow diagram illustrating a possible embodiment of a method for configuring multiple functions within a domain name registering system by each function parsing an electronic document for business requirements relevant to that function.

FIG. 18 is a flow diagram illustrating a possible embodiment of a method for creating an electronic document using data from one or more functions within a domain name registering system.

FIG. 19 is a flow diagram illustrating a possible embodiment of a method for creating an electronic document using data from one or more functions within a domain name registering system and then storing the electronic document in a database that stores other electronic documents.

FIG. 20 is an example of an electronic document or a portion of an electronic document written in TLDML for data related to stages of a domain name.

FIG. 21 is an example of an electronic document or a portion of an electronic document written in TLDML for data related to nameservers for a domain name.

FIG. 22 is an example of an electronic document or a portion of an electronic document written in TLDML for data related to launch phases for a domain name.

FIGS. 23-30 are an example of an electronic document written in TLDML.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Prevalent on the Web are multimedia websites, some of which may offer and sell goods and services to individuals and organizations. Websites may consist of a single webpage, but typically consist of multiple interconnected and related webpages. Websites, unless extremely large and complex or have unusual traffic demands, typically reside on a single server and are prepared and maintained by a single individual or entity. Menus and links may be used to move between different webpages within the website or to move to a different website. The interconnectivity of webpages enabled by the Internet can make it difficult for Internet users to tell where one website ends and another begins.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited Registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

One problem often encountered in registering domain names is that the desired domain name has already been registered to another registrant. To help with the scarcity of domain names, additional TLDs may be added to the domain name registration system. For example, generic top-level domains (gTLD) may be added to the domain name system from time-to-time to help with this problem. Another solution is to allow people (or businesses) to register new TLDs. For example, Go Daddy Operating Company, LLC may desire to register .godaddy as a new TLD. Either method of adding new TLDs greatly expands the number of possible domain names that may be registered.

The addition of new TLDs requires domain name registering entities (typically Registrars and their resellers, but includes any entity that can register a domain name) to update many of their internal functions to allow registrants to register domain names having the new TLDs.

A large part of the difficulty in adding new TLDs is that each TLD may (and usually does) have unique business requirements. As non-limiting examples, the business requirements for a TLD may include whether the thick or thin Registry model is being used, minimum and maximum registration periods, valid registration periods, length of any registration grace periods, billing requirements, domain name transfer requirements, auto renewal requirements, reseller information, and so on. Each TLD may have its own combination of business requirements that must be correctly handled by the domain name registering entity.

The present invention is much more efficient at launching new TLDs and in handling changes to existing TLDs. Prior methods of hard coding or storing across multiple databases, without having an authoritative or prime database, business requirements for TLDs can make changes to the system very time consuming and difficult. On the other hand, the present invention provides a means for updating a single source, such as an electronic document stored in a database, and then the system propagating the business requirements to one or more functions within the domain name registering entity that then programmatically configure the Registrar to properly handle the new TLD or changes to existing TLDs.

The efficiency in adding new TLDs and reconfiguring for existing TLDs is very important as new TLDs are being added at an ever increasing pace. As domain name registering entities add TLDs with business requirements that conflict with business requirements for existing TLDs, the complexity of the domain name registering entity could grow exponentially unless a scalable solution, such as the present invention, is implemented. It is important for the domain name registering entity to keep a streamlined on-boarding process, and thus a low time to market, as new TLDs are added to its offered products.

The present invention provides greater control over TLD behavior. The quantity, variety, and complexity of TLDs under management by a domain name registering entity are greatly benefited by a strong control structure. The present invention may simplify making changes to the domain name registering entity, determining which TLD business rules are currently in effect and even adding entirely new TLD business rules. Certain embodiments of the present invention also make it easier for nontechnical employees to access the TLD business rules, thereby freeing developers from this task and allowing a greater number of employees (for example, marketing, project managers, customer service, etc.) of the domain name registering entity to access the business rules for TLDs currently being used.

Some embodiments of the present invention may use a Top-Level Domain Markup Language (TLDML). TLDML is a markup language that describes the attributes and business rules for a top-level domain. Unlike Extensible Markup Language (XML), TLDML is preferably a strictly defined markup language where every tag has a pre-defined meaning Tags are preferably not introduced unless their meaning is first clearly defined. Similar to how HTML instructs a browser how to render a page to an end user, TLDML instructs a domain name registering entity how to manage a top-level domain subject to the registry's requirements. A TLD's business rules will typically include many, if not all, of the registry's requirements. In some embodiment, the TLDML may also describe attributes specifically determined by the domain name registering entity in offering the TLD. A Registrar may create the format and specify the data points that will be captured in a TLDML document.

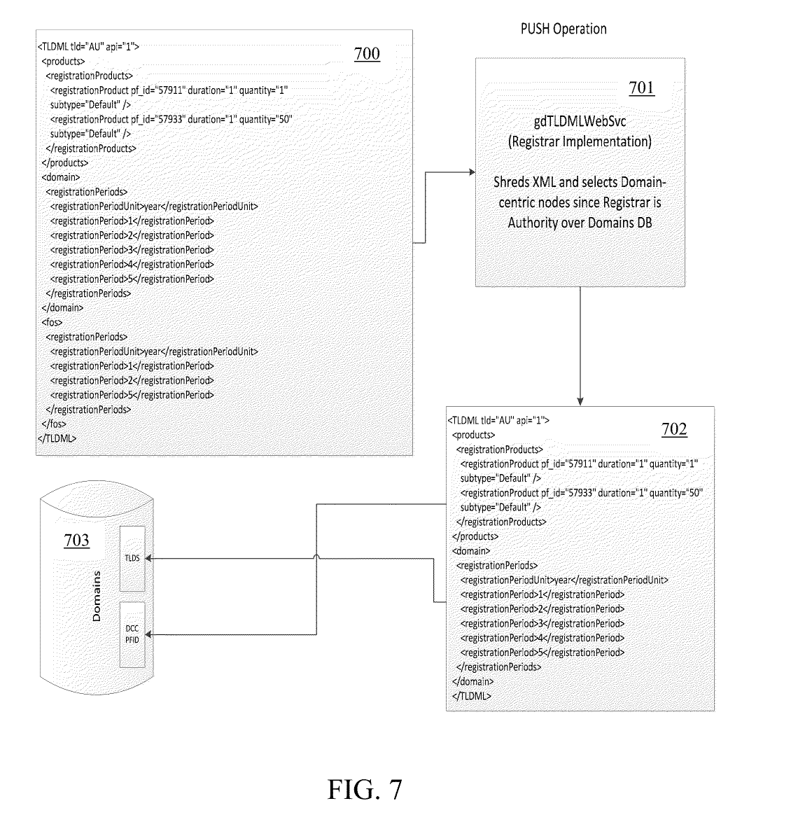

Non-limiting examples of TLDMLs documents (or portions of documents) are shown in FIGS. 7, 8, 9, 20, 21, 22, and 23.

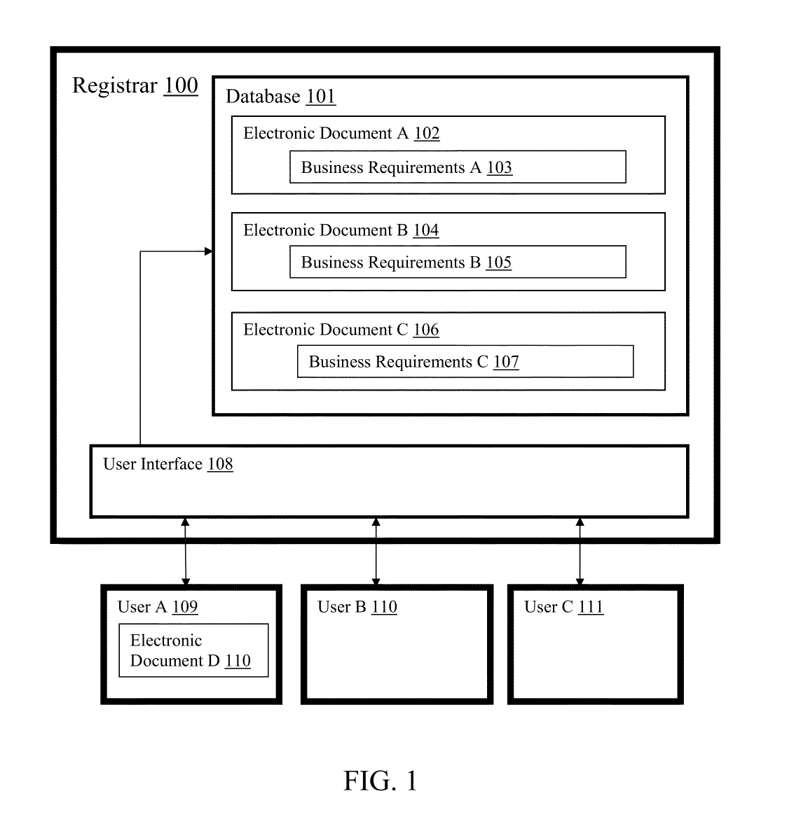

FIG. 1 illustrates an example system that may quickly be updated to allow the registration of new TLDs. A Registrar 100 is illustrated in FIGS. 1-4 because a Registrar 100 is the most likely user of the present invention. However, it should be appreciated that the Registrar 100 in FIGS. 1-4 may be replaced by any domain name registering entity. For purposes of this invention, a domain name registering entity should be broadly construed as any entity that is capable of registering a domain name to a registrant.

The Registrar 100 may include a database 101 (also referred to as an electronic document database). The database 101, as non-limiting examples, may be a central, distributed, flat, hierarchical, network, relational, object-oriented or any other type of database now known or developed in the future. The database 101 may store one or more electronic documents used as part of this invention. Three electronic documents (A 102, B 104, and C 106) are illustrated in FIGS. 1-4 as an example of one possible configuration.

The electronic documents 102, 104, 106 may be stored in any data format, such as in files, electronic records or any other data structures now known or discovered in the future. The electronic documents 102, 104, 106 may be written in any language. However, the electronic documents are preferably written in a structured markup language and are most preferably written in TLDML.

While an electronic document 102, 104, 106 may contain business requirements for more than one TLD, in preferred embodiments each electronic document 102, 104, 106 contains data representing the business requirements 103, 105, 107 for one, and only one, TLD. It is also preferred that no two electronic documents 102, 104, 106 contain business requirements 103, 105, 107 for the same TLD. Thus in the most preferred embodiments, each electronic document 102, 104, 106 contains business requirements 103, 105, 107 for a single unique TLD. Fewer or more electronic documents 102, 104, 106 may be subtracted or added as needed from that illustrated in FIGS. 1-4. In preferred embodiments, there will be one electronic document 102, 104, 106 for each TLD offered for registration by the Registrar 100. The database 101 may store more data than just the electronic documents 102, 104, 106 if so desired by the Registrar 100.

In another embodiment, electronic documents 102, 104, 106 contain business requirements 103, 105, 107 for one, and only one, second level domain (SLD). For example, each electronic document 102, 104, 106 may store business requirements for the SLDs com.au, net.au, and org.au. In another embodiment, one or more electronic documents 102, 104, 106 may contain the business requirements 103, 105, 107 for a TLD, while one or more other electronic documents 102, 104, 106 store business requirements 103, 105, 107 for a SLD.

In another embodiment, a Registrar 100 may support two or more intermediary proxy registration providers. If the two or more intermediary proxy registration providers have different business requirements, it may be desirable for the Registrar 100 to have one electronic document (storing business requirements for one TLD) for each proxy registration. So if a Registrar 100 had three intermediary proxy registration providers, the Registrar would have three electronic documents 102, 104, 106. Each of the three electronic documents 102, 104, 106 would store business requirements for the same TLD, but for different intermediary proxy registration providers. This may be scaled so the Registrar 100 may support any number of TLDs desired by creating additional electronic documents 102, 104, 106 for any number of intermediary proxy registration providers.

A user interface 108 (or computer interface) may be provided that is in communication with a plurality of users 109, 110, 111 over a computer network, such as the Internet. Users 109, 110, 111 may communicate with the user interface 108 through, for example, an API or other network protocol. The Registrar 100 may use the user interface 108 to receive an electronic document D 110 (containing business requirements) from a user 109. If the electronic document is already in the desired format, it may be stored in database 101. Otherwise, the electronic document may be edited to the desired format before storing the electronic document D in the database 101. This is one possible method for the Registrar to receive business requirements for a TLD. The business requirements may be for a new TLD (a TLD not previously offered by the Registrar 100) or an existing TLD (a TLD already offered by the Registrar 100) having updated business requirements.

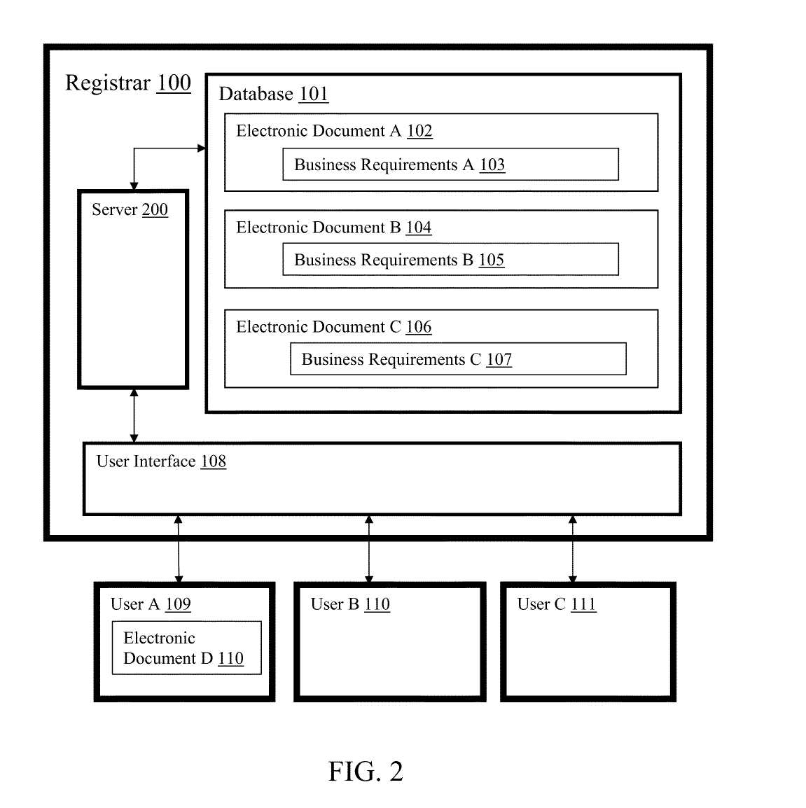

FIG. 2 illustrates another embodiment where the Registrar 100 may receive data for a new electronic document D 110 from user A 109. If only data is being provided by user A 109, the user interface 108 may have fields, pull down menus, etc. that allow user A 109 to easily and efficiently enter the data. The user interface 108 may also be constructed to allow a file containing the data to be received by the user interface 108. A server 200 (in communication with the user interface 108 and the database 101) may be used to convert the data into an electronic document in the desired format or language before storing the electronic document into the database 101.

In another embodiment, the user interface 108 and/or the server 200 are configured to: 1) read an electronic document A 102 from the plurality of electronic documents A 102, B 104, C 106, 2) programmatically allow the electronic document A 102 to be modified, and then 3) store the modified electronic document A 102 back into the electronic document database 101.

In another embodiment, the user interface 108 may be configured with the server 200 to: 1) accept a plurality of new business requirements for a new TLD, 2) create a new electronic document that includes the plurality of new business requirements for the new TLD, and 3) store the new electronic document in the electronic document database 101. The creation of the new electronic document may be accomplished by a software program that runs on one or more servers 200 in the Registrar 100. The software program may take the business requirements and create the new electronic document in the desired format or language (such as TLDML) and then store the electronic document in the database 101.

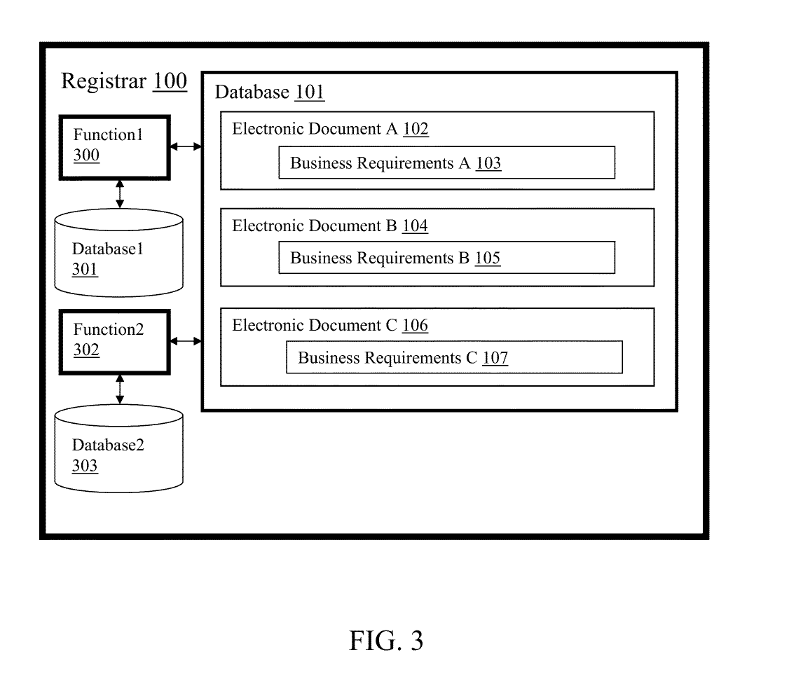

FIG. 3 illustrates another embodiment of the invention. A Registrar 100 may be organized into a plurality of different application specific implementations (functions). As non-limiting examples, these functions may be a domain name registration function, a front of site (FOS) function, an e-commerce function, an internal apps function, and/or a domain control center function. The FOS function may be responsible for displaying and handling the exchange of information between the users A 109, B 110, C 111 and the website 401.

These particular functions are not necessarily required for the present invention, may be organized into different functions and/or additional functions may be added or combined as desired. Whichever functions are used by the Registrar 100 (represented by Function1 300 and Function2 302 in FIG. 3), the functions are preferably in communication with the electronic document database 101. A plurality of web services may be used to facilitate communication between the various functions and the database 101.

This embodiment illustrates that one or more of the functions may have a separate database (represented by Database1 301 in communication with Function1 300 and Database2 303 in communication with Function2 302) in which to store data. In a preferred embodiment, Function1 300 cannot access database2 303 and Function2 302 cannot access database1 301.

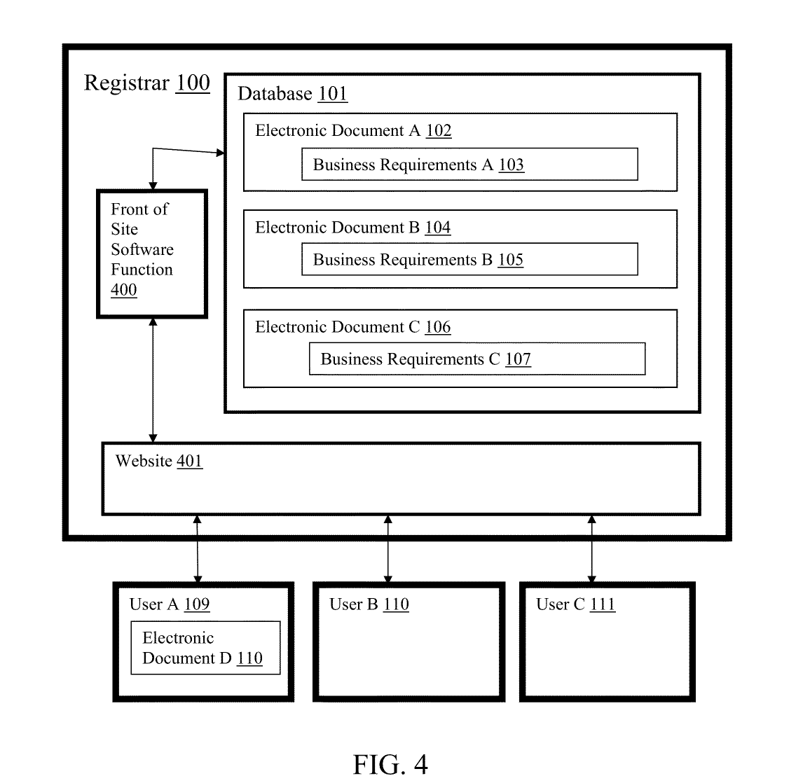

FIG. 4 illustrates a possible embodiment of an enhanced domain name registration system (Registrar 100) with a Website 401 and a front of site software function 400. The front of site software function 400 may be in communication with the electronic document database 101 to be able to receive electronic documents 102, 104, 106 containing the business requirements 103, 105, 107 for a plurality of TLDs. The front of site software function 400 may then programmatically configure the website 401 according to the received business requirements to allow users A 109, B 110, C 111 to register domain names having the plurality of TLDs.

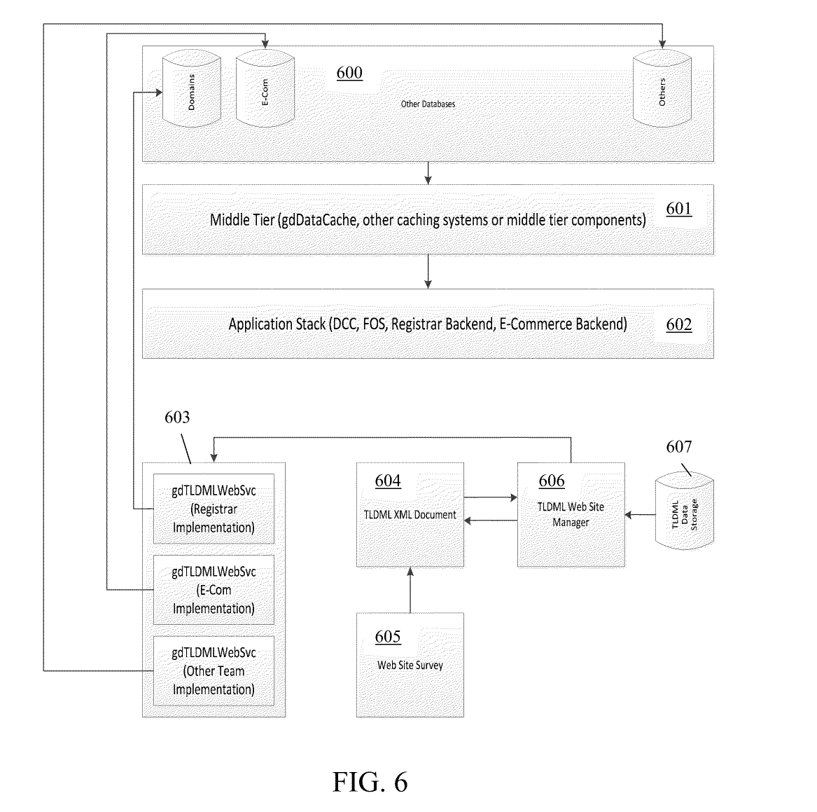

FIG. 6 illustrates a possible embodiment of an enhanced domain name registration system with a middle tier 601, an application stack 602, multiple web services 603 and functions having their own databases 600. A web site survey 605 may be used to view, edit, enter data, or enter a TLDML XML document 604. A TLDML web site manager 606 may be used to manage the flow of the TLDML XML document 604 between the web site survey 605, the TLDML data storage 607 and the web services 603 and functions within the domain name registering entity. The TLDML XML document 604 may be stored in the TLDML data storage 607.

When a TLDML XML document is created or changed it may be pushed by the TLDML web site manager 606 to the web services 603 and functions. Alternatively, the web services 603 and functions may pull the TLDML XML document from the TLDML web site manager 606 which may retrieve the TLDML XML document 604 from the TLDML data storage 607. Alternatively, the web services 603 may call a TLDMS web service to retrieve the TLDML XML document. In another embodiment, the web services 603 may not be web services at all, but services supported within the domain name registering entity 100.

Direct links between gdTLDMLWebSvc and the appropriate data stores are illustrated. For example, the gdTLDMLWebSvc hosted by a registrar team may have a direct link to the domains database, the web service hosted by e-commerce may have a direct link to the e-commerce database, and the “other” team implementation is left as a place holder to illustrate how other teams that own authoritative data may onboard with a TLDML document for their function.

As data becomes updated in places of authority, as seen in the diagram, the new values may be promoted to the middle tier, and eventually the application stack. In this example architecture, TLDML documents will always cause data to be updated in places of authority in order to promote a trickledown effect.

FIG. 7 illustrates a possible embodiment of a Registrar implementation 701 function of an enhanced domain name registration system. In this embodiment, the Registrar implementation 701 may take a TLDML document 700 and parse (shred) the document to create a new document 702 that contains only the business requirements relevant to the Registrar implementation 701. The new document may then be stored in a domains database 703 for quick access by the Registrar implementation 701. While creating a new document 702 is not mandatory (the TLDML document 700 could be stored in the domains database 703 as is), it is helpful in that less information has to be stored and the new document 702 is easier and faster for the Registrar implementation 701 to search.

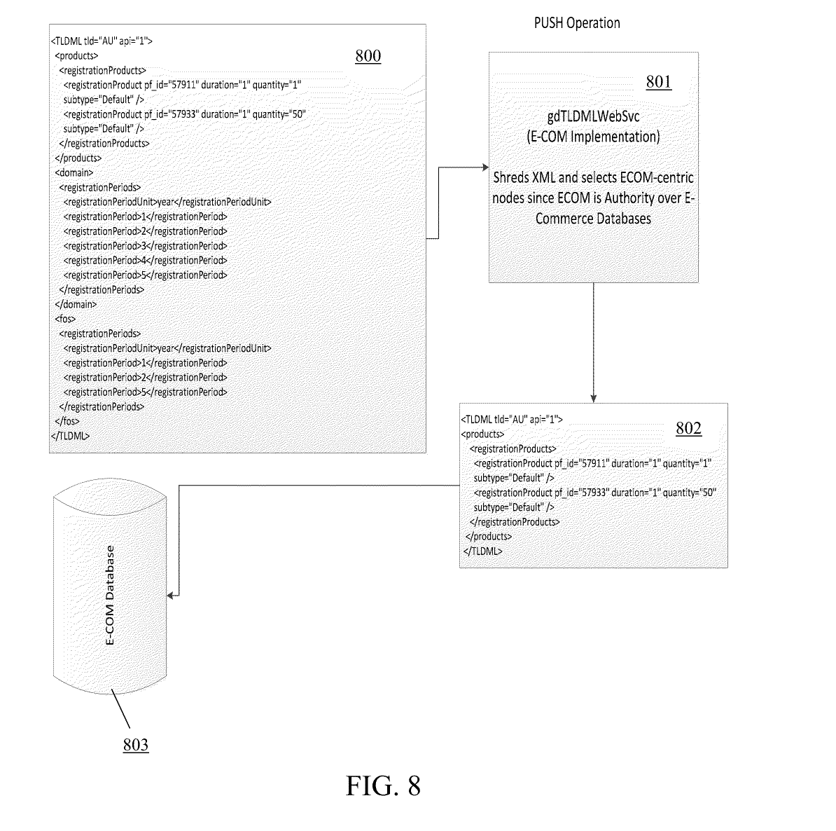

FIG. 8 illustrates a possible embodiment of an e-commerce implementation 801 function of an enhanced domain name registration system. In this embodiment, the e-commerce implementation 801 may take a TLDML document 800 and parse (shred) the document to create a new document 802 that contains only business requirements relevant to the e-commerce implementation 801. The new document may then be stored in an e-commerce database 803 for quick access by the e-commerce implementation 801. While creating a new document 802 is not mandatory (the TLDML document 800 could be stored in the e-commerce database 803 as is), it is helpful in that less information has to be stored and the new document 802 is easier and faster for the E-Commerce implementation 801 to search.

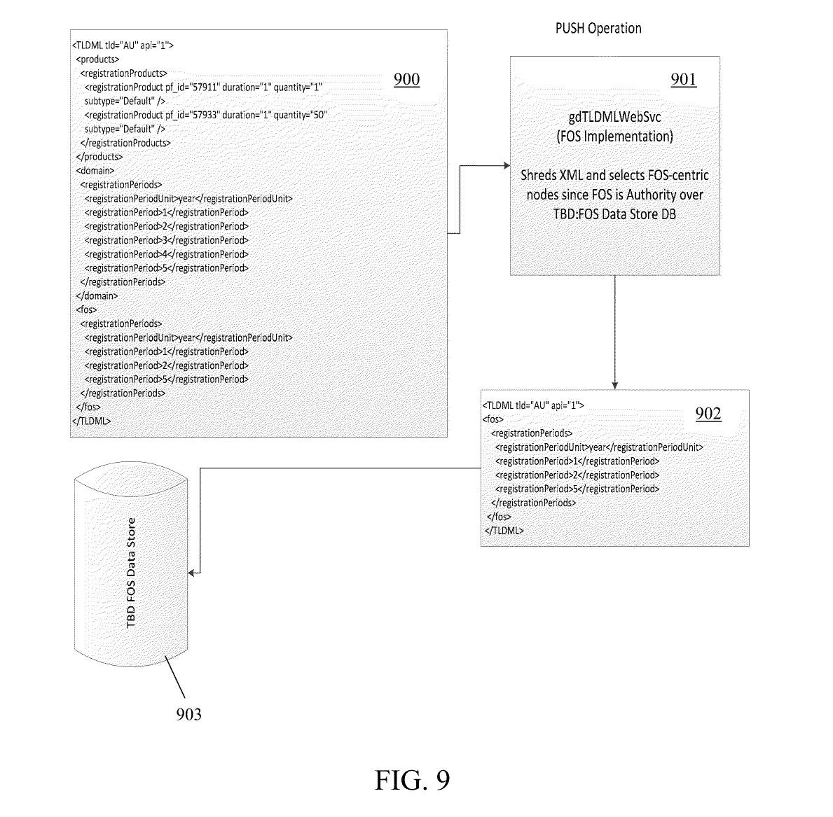

FIG. 9 illustrates a possible embodiment of a front of site (FOS) implementation 901 of an enhanced domain name registration system. In this embodiment, the FOS implementation 901 may take a TLDML document 900 and parse (shred) the document to create a new document 902 that contains only business requirements relevant to the FOS Implementation 901. The new document may then be stored in the FOS database 903 for quick access by the FOS implementation 901. While creating a new document 902 is not mandatory (the TLDML document 900 could be stored in the FOSS data store 903 as is), it is advantageous in that less information has to be stored and the new document 902 is easier and faster for the FOS Implementation 901 to search.

While the embodiments illustrated in FIGS. 7-9 have been explained with a TLDML document (the preferred format), an electronic document or a structured markup language document may also be used.

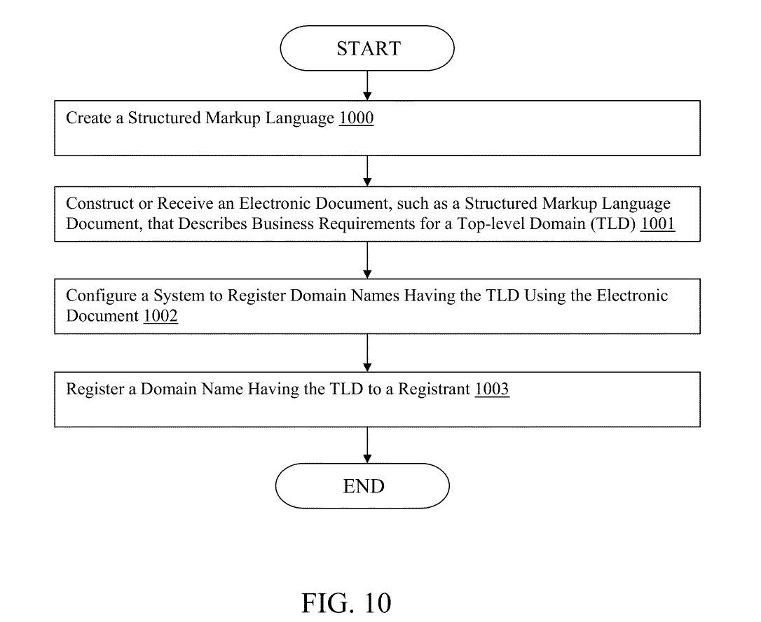

FIG. 10 is a flow diagram illustrating a possible embodiment of a method for configuring a domain name registering entity to register domain names having a TLD. In this embodiment, a format for the electronic documents 102, 104, 106 is created. The format may be a structured markup language such as a TLDML. (Step 1000) The step of creating a structured markup language generally only needs to be completed once (preferably by the Registrar 100), since all future TLDs may use the same structured markup language to write their electronic documents.

An electronic document A 102, written in the created format or language, may be constructed or received that describes a plurality of business requirements A 103 for a top-level domain (TLD). (Step 1001) The electronic document A 102 may be constructed from business requirements A 103 entered by user A 109 via the user interface 108 or an API (Website 401). One or more servers 200 may be used to turn the business requirements A 103 into an electronic document A 102 having the created format or language. Alternatively, an electronic document D 110 may be received from a user A 109 via the user interface 108 or API (Website 401) already in the created format or language.

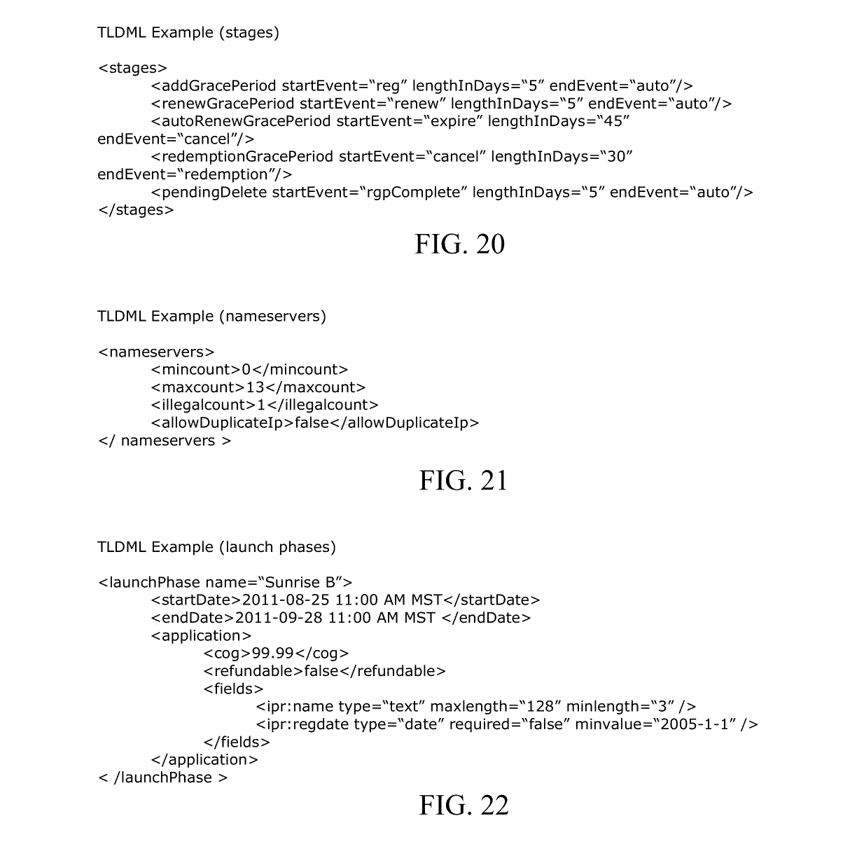

The electronic document A 102 once created, may be considered the authoritative source in the Registrar 100 for the plurality of business requirements A 103 for the TLD. Example electronic documents A 102, B 104, C 106 are illustrated in FIG. 7 as 700, in FIG. 8 as 800, in FIG. 9 as 900, and in FIGS. 20-23.

The user 109 may be an employee of the domain name registering entity or Registrar 100, the employee of a Registry or an employee of a registrant (owner) of the TLD. In any event, the user 109 is preferably a trusted source for providing business requirements (or an electronic document D 110) for the TLD.

The created or received electronic document A 102 may be used to configure a system (such as a domain name registering entity or a Registrar 100) to register a plurality of domain names having the TLD. (Step 1002) Once the system is configured, domain names having the TLD may be registered to one or more registrants. (Step 1003)

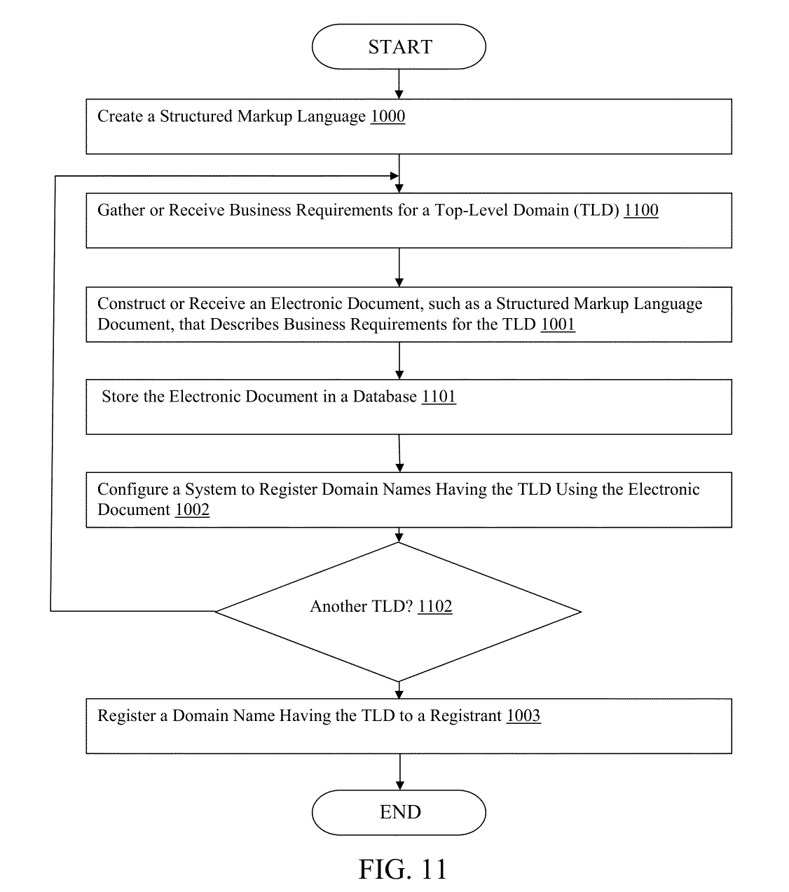

FIG. 11 is a flow diagram illustrating a possible embodiment of a method for configuring a Registrar 100 to register domain names having multiple TLDs. This illustrated embodiment is similar to the embodiment illustrated in FIG. 10, but adds the additional steps of receiving business requirements for a TLD (Step 1100) and storing a constructed electronic document A 102 for the TLD in a database 101 (Step 1101). As in the embodiment illustrated in FIG. 10, the Registrar 100 may then be programmatically configuring to register domain names having the TLD (Step 1002). These steps (1100, 1001, 1101, 1002) may be repeated for any number of additional TLDs desired to be registered by the Registrar 100. (Step 1102) For example, if the Registrar 100 wanted to register domain names having the TLDs of .com and .org, the process may be completed twice, once using the business requirements for .com and once using the business requirements for .org. In this manner, the Registrar 100 may be efficiently configured to register both TLDs. In addition, if the Registrar 100 wishes to register domain names having different TLDs at a later date, the process may be repeated at any time using the business requirements for those additional TLDs.

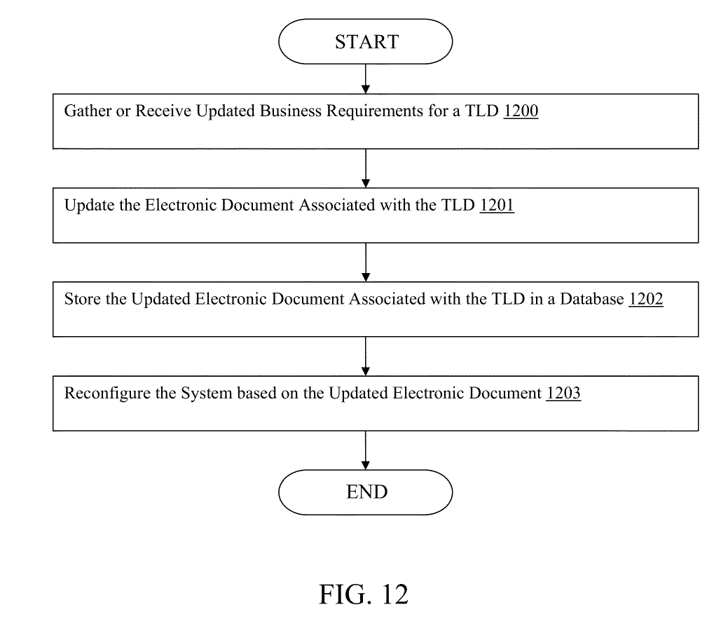

FIG. 12 is a flow diagram illustrating a possible embodiment of a method for programmatically reconfiguring a system to register domain names having a TLD. One of the advantages of the present invention is that it allows a Registrar 100 to be easily updated when the business requirements for a TLD change. The first step is for the Registrar 100 to receive the updated business requirements for the TLD that is already being offered for registration. (Step 1200) The updated business requirements may be received, for example, via a user interface 108, website 401, API or any other method known or discovered in the future. The Registrar 100 may update the electronic document associated with the TLD, either by modifying the old electronic document or by creating a new electronic document (Step 1201), and then storing the updated electronic document back into the database 101 (Step 1202). Preferably, the electronic document should be for one, and only one, TLD and no two electronic documents in the database 101 should be for the same TLD. The Registrar 100 may then be reconfigured to reflect the business requirements in the updated electronic document. (Step 1203)

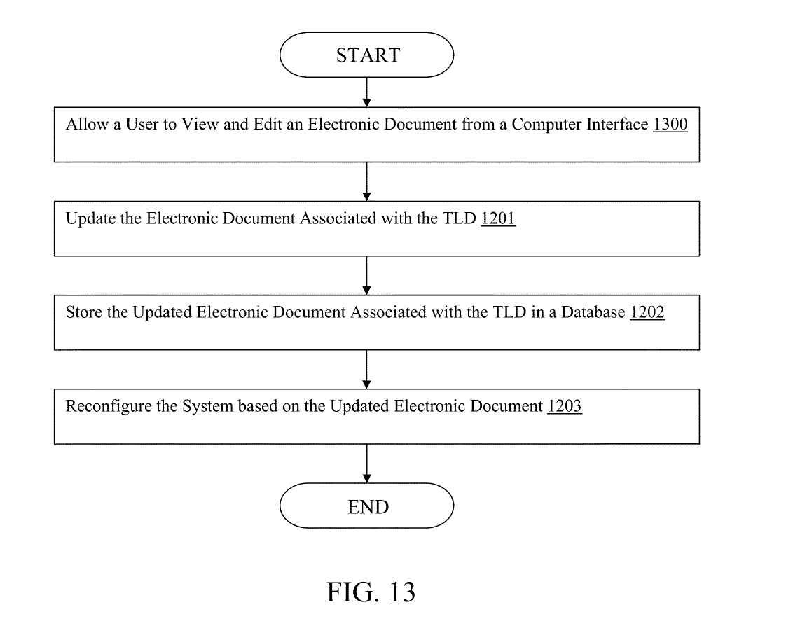

FIG. 13 is a flow diagram illustrating a possible embodiment of a method for configuring a system to register domain names having a TLD. This embodiment adds to the embodiment of FIG. 12 by enabling a computer interface, user interface 108, website 401 or API to allow a user A 109 to view and edit the electronic document A 102 associated with the TLD in the plurality of electronic documents A 102, B 104, C 106 in the database 101. (Step 1300) This greatly simplifies the process for updating and reconfiguring the Registrar 100.

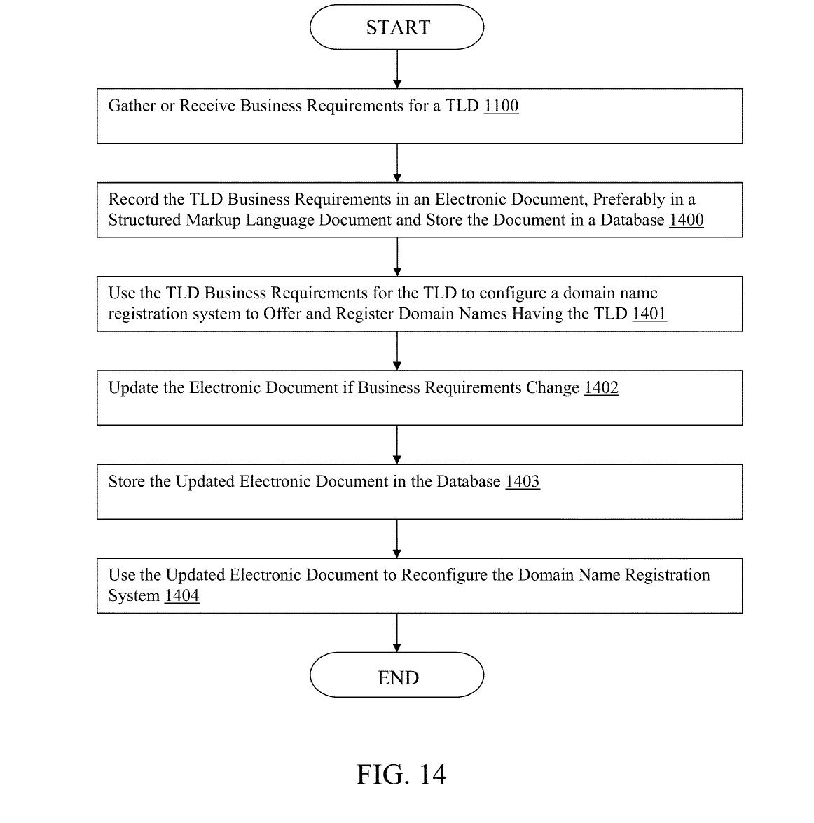

FIG. 14 is a flow diagram illustrating a possible embodiment of a method for configuring a system to register domain names having a TLD and then reconfiguring the system if the business requirements for the TLD change. In this embodiment the business requirements A 103 for a TLD are gathered or received, preferably as described above for FIG. 13. (Step 1100) The gathered TLD business requirements A 103 may be recorded or written into an electronic document A 102, such as a structured markup language document or a TLDML document 900, and then stored in a database 101. (Step 1400) The Registrar 100 may be programmatically configured using the business requirements A 103 recorded in the electronic document A 102. (Step 1401) If the business requirements A 103 for the TLD subsequently change, the electronic document A 102 may be updated to reflect the new business requirements for the TLD (Step 1402) and then stored back into the database 101 (Step 1403). The updated electronic document A 102 may then be used to reconfigure the Registrar 100 (Step 1404) to allow domain names having the TLD (with the updated business requirements) to once again be registered by the Registrar 100.

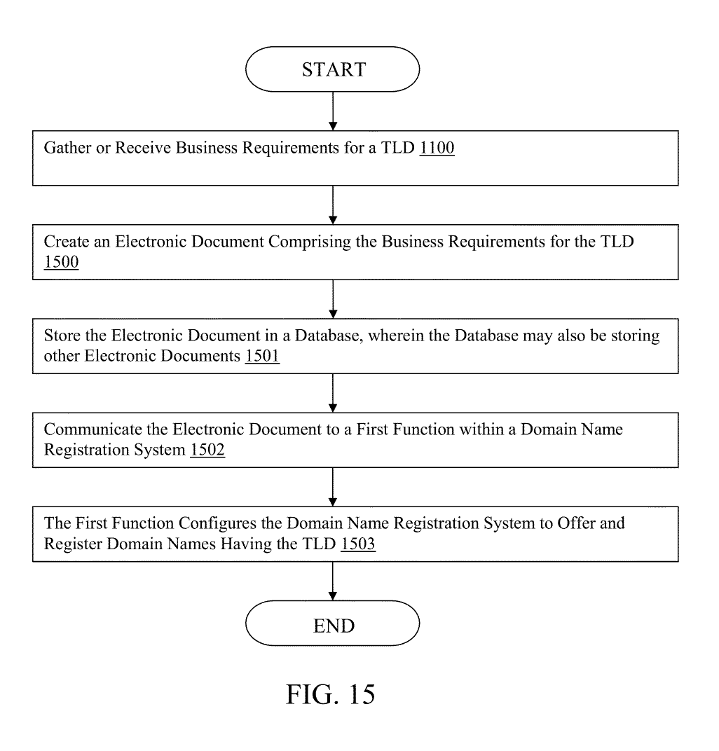

FIG. 15 is a flow diagram illustrating a possible embodiment of a method for configuring a first function within a Registrar 100. As in other embodiments, business requirements for a TLD may be gathered or received in any manner previously mentioned, known or discovered in the future. (Step 1100) An electronic document A 102 may be created or received that includes the business requirements A 103 for a TLD. (Step 1500) The electronic document A 102 may be stored in a database 101. (Step 1501) The electronic document A 102 may be pushed to, or pulled from, function1 300 within the Registrar 100. (1502) Function1 300 may be any function performed by the Registrar 100 that uses business requirements A 103 of the TLD to perform its purpose. As non-limiting examples, function1 300 may be to operate the front of site, perform registration of domain names or complete e-commerce transactions. Function1 300, having received the business requirements A 103 for the TLD, may then configure its area of responsibility within the Registrar 100. (Step 1503) The Registrar 100 may be updated as TLD business requirements change as described in previous embodiments.

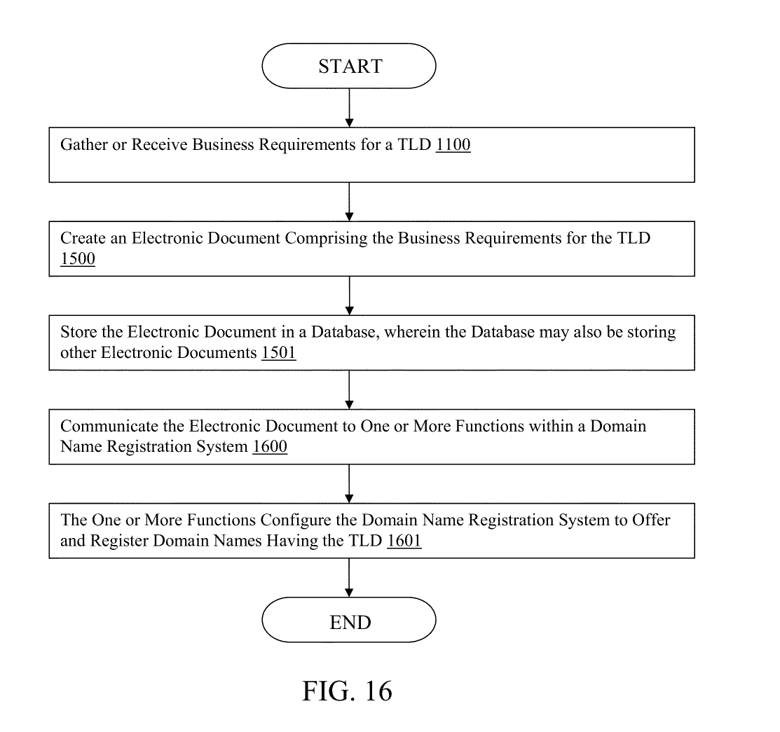

FIG. 16 is a flow diagram illustrating a possible embodiment of a method for configuring multiple application specific implementations 508-512 (functions) within a Registrar 100. This embodiment is similar to the embodiment discussed in relation to FIG. 15, but the electronic document A 102 may be pushed to, or pulled by, a plurality of functions, such as function1 300 and function2 302, within the Registrar 100 from a database 101. (Step 1600) In preferred embodiments, every function within the Registrar 100 that uses business requirements A 103 for TLDs will receive the electronic document A 102. For example, an electronic document A 102 containing the business requirements for .com may be pushed to or pulled by the functions of operating the front of site, performing registration of domain names and completing e-commerce transactions. At the same or different times, a different electronic document B 104 containing the business requirements B 105 for .org may be pushed to or pulled by the same functions of operating the front of site, performing registration of domain names and completing e-commerce transactions. These functions may be programmatically configured (and thus the Registrar 100) via software according to the business requirements A 103, B 105 in the electronic documents A 102, B 104 respectively. (Step 1601) In this manner, all the functions within a Registrar 100 may receive all the business requirements for all of the TLDs being offered by the Registrar 100. As in other embodiments, if the electronic documents A 102, B 104 are updated, the functions may programmatically reconfigure themselves (and thus the Registrar 100) via software according to the business requirements in the updated electronic document(s).

A Registrar 100 may be logically broken down into any number of different functions and this invention should not be limited by the number or the specific functions selected within the Registrar 100.

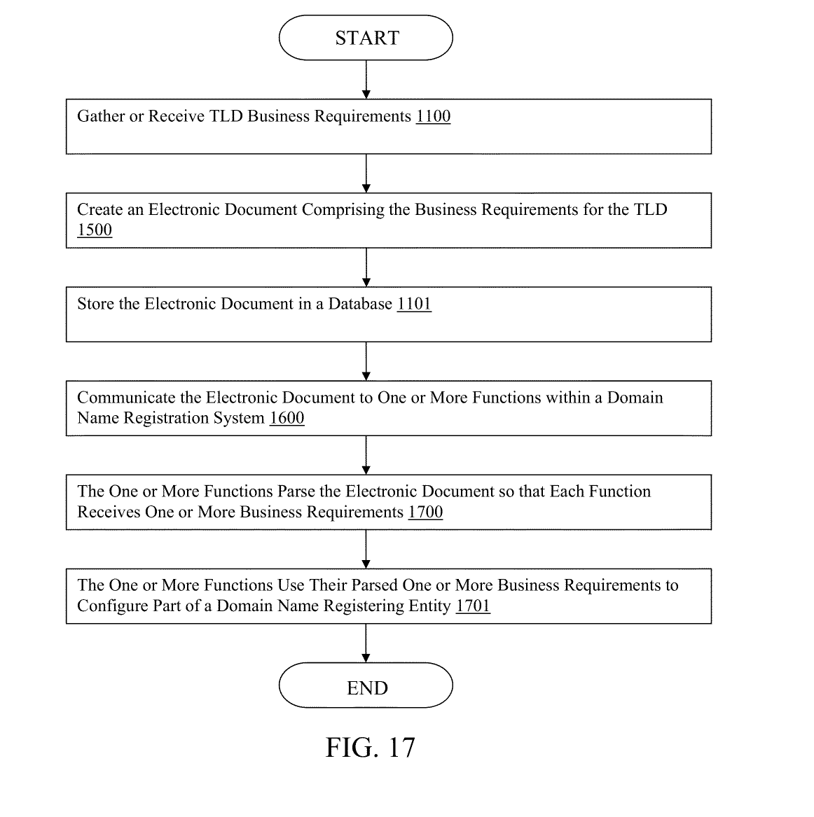

FIG. 17 is a flow diagram illustrating a possible embodiment of a method for configuring multiple functions within a domain name registering system by each function parsing an electronic document for business requirements relevant for that function. This embodiment is similar to the embodiment explained in regards to FIG. 16, but includes the added steps of the functions parsing the electronic documents for the specific business requirements the functions requires (which may vary from function to function) (Step 1700). Each function may use its parsed business requirements to configure itself (and thereby configure the Registrar 100). (Step 1701) For example, function1 300 may store the electronic document A 102 in database1 301, but preferably stores only the parsed business requirements needed by function1 300. Likewise, function2 302 may store the electronic document A 102 in database2 303, but preferably stores only the parsed business requirements needed by function2 302 which may be substantially different than the parsed business requirements needed by function1 300.

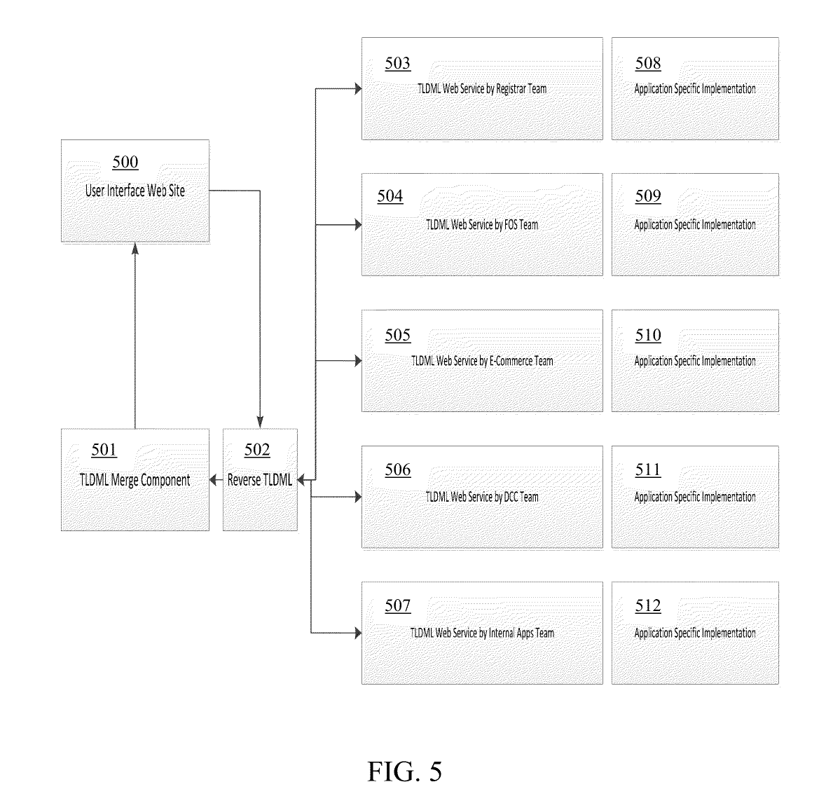

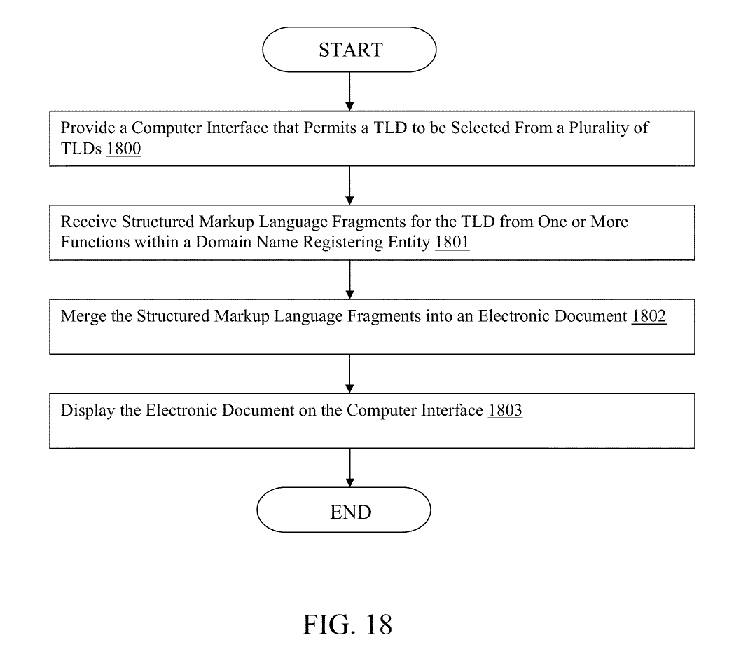

FIG. 5 illustrates a possible embodiment of an enhanced domain name registration system with multiple different web services 503-507 with corresponding application specific implementations 508-512 (also referred to as functions), a user interface web site 500, a TLDML merge component 501 and a reverse TLDML 502 function. FIG. 18 is a flow diagram illustrating a possible embodiment of a method for creating an electronic document using data from one or more functions within a domain name registering system. It may be desirable to see what business requirements are currently being used by a Registrar 100 for a particular TLD or even for multiple TLDs. The embodiments illustrated in FIGS. 5 and 18 assist a user A 109 in determination which business requirements are currently being used by the Registrar 100 as will now be described.

A user interface web site 500 may be provided to allow a user A 109 to select a TLD from a plurality of TLDs. (Step 1800) The selected TLD is the TLD that the user A 109 wishes to see the business requirements for the TLD that are currently being used. A reverse TLDML 502 may ask one or more application specific implementations 508-512 (functions) via their corresponding TLDML web services 503-507 which business requirements they are using.

The application specific implementations 508-512 may respond, via their TLDML web services 503-507, to the reverse TLDML 502 with the business requirements that each application specific implementation 508-512 is using. (Step 1801) For example, the reverse TLDML 502 may receive a plurality of structured markup language fragments (or an entire electronic document) for the TLD from the one or more application specific implementations 508-512 (functions) within the Registrar 100.

The TLDML merge component 501 may use the information retrieved by the reverse TLDML 502 to create an electronic document showing the business requirements currently being used by a Registrar 100 for the selected TLD by merging or combining the information together. (Step 1802) Duplicate information may be ignored, while conflicting information may be flagged as a possible problem in the electronic document.

The electronic document may then be displayed for the user A 109 on the user interface web site 500. (Step 1803) For this embodiment, the electronic document may be in a human readable format (such as plain text or data within fields provided on the user interface web site 500) since the electronic document is primarily for human consumption and interaction.

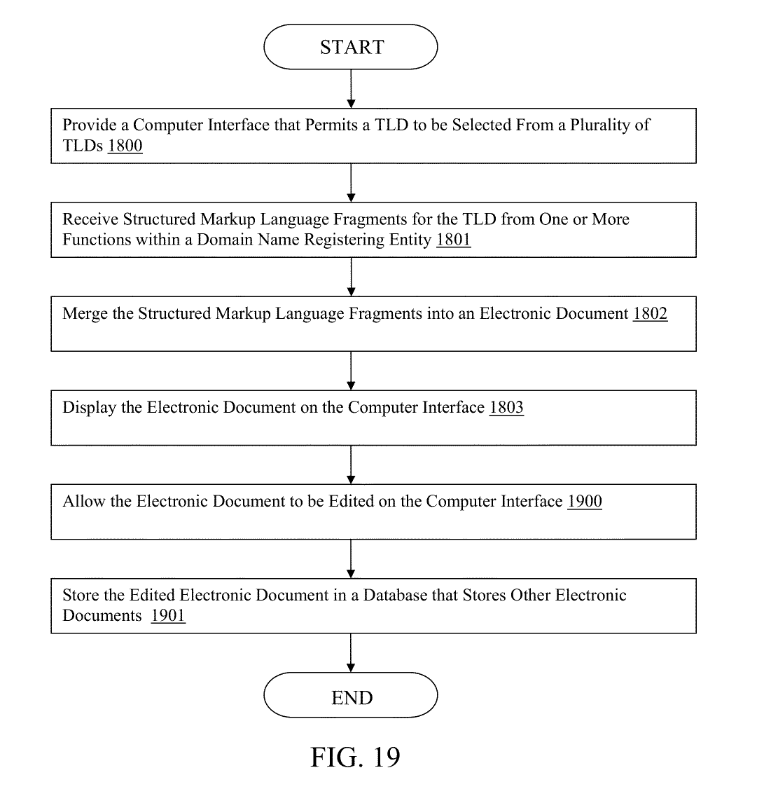

FIG. 19 is a flow diagram illustrating a possible embodiment of a method for creating an electronic document using data from one or more functions within a domain name registering system and then storing the electronic document in a database that stores other electronic documents. This embodiment is an enhancement to the embodiments illustrated in FIGS. 5 and 18. User A 109 may edit the electronic document being displayed on the user interface web site 500. (Step 1900) The electronic document may then be stored in a database 101 if the user A 109 has permission and desires to do so. (Step 1901) The Registrar 100, by either pushing the electronic record to the plurality of functions within the domain name registration system or by the plurality of functions within the domain name registration system pulling the electronic record, may then be programmatically reconfigured to reflect the edited electronic document.

FIG. 20 is an example of a portion of an electronic document, an extended markup language document, a TLDML document and a TLDML XML document for data related to stages within the life cycle of a domain name. The illustrated electronic document could be stored in a database 101 and used by a Registrar 100 to configure (or reconfigure) the Registrar's various functions.

FIG. 21 is an example of a portion of an electronic document, an extended markup language document, a TLDML document and a TLDML XML document for data related to nameservers for a domain name. The illustrated electronic document could be stored in a database 101 and used by a Registrar 100 to configure (or reconfigure) the Registrar's various functions.

FIG. 22 is an example of a portion of an electronic document, an extended markup language document, a TLDML document and a TLDML XML document for data related to launch phases for a domain name. The illustrated electronic document could be stored in a database 101 and used by a Registrar 100 to configure (or reconfigure) the Registrar's various functions.

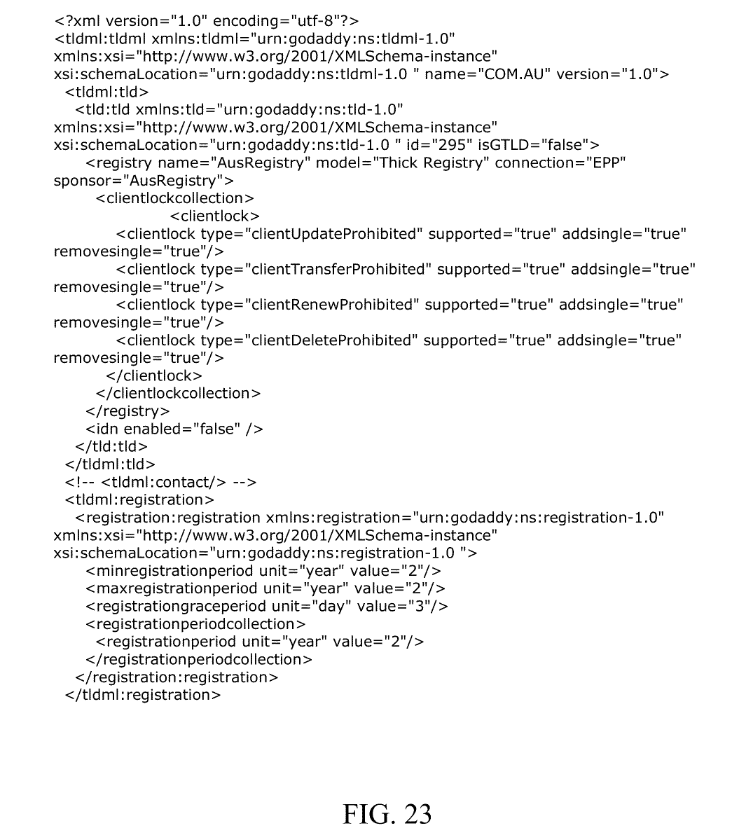

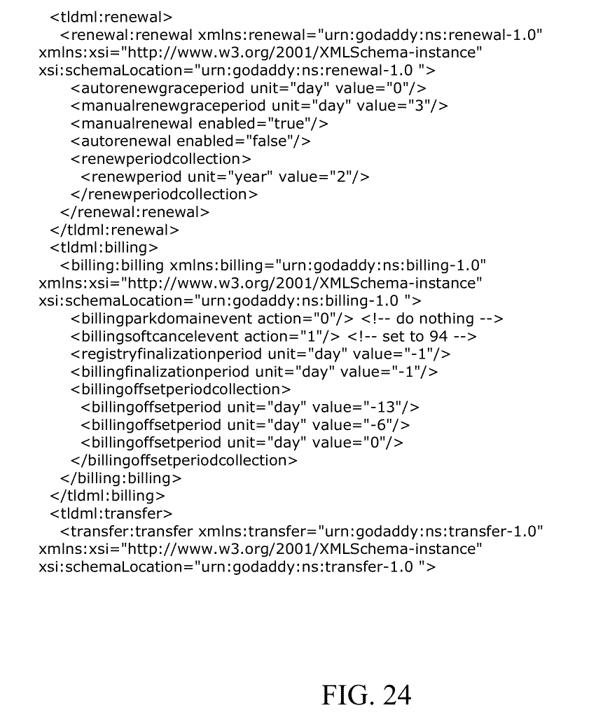

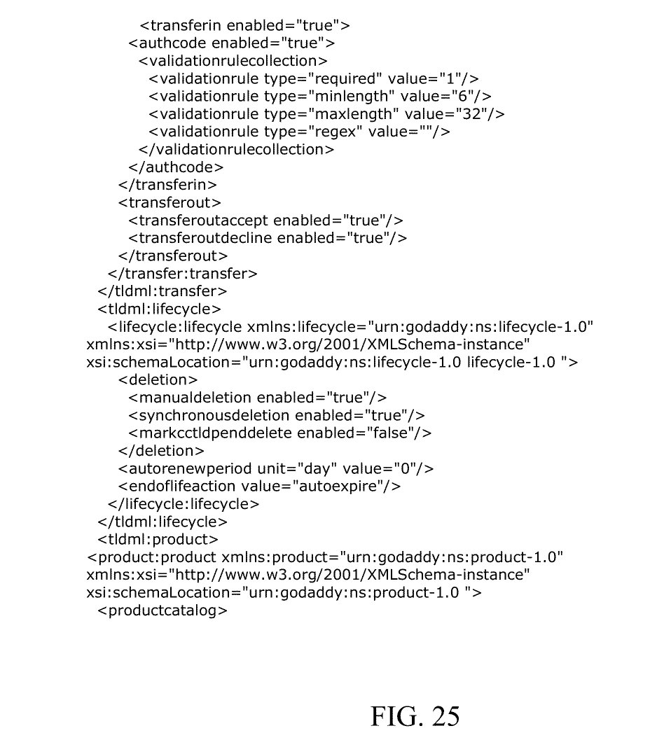

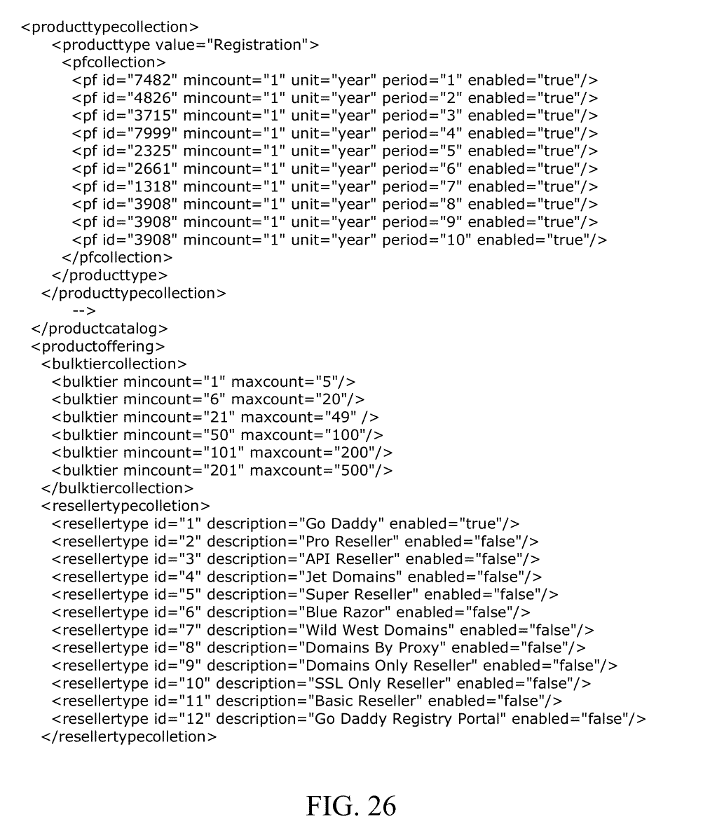

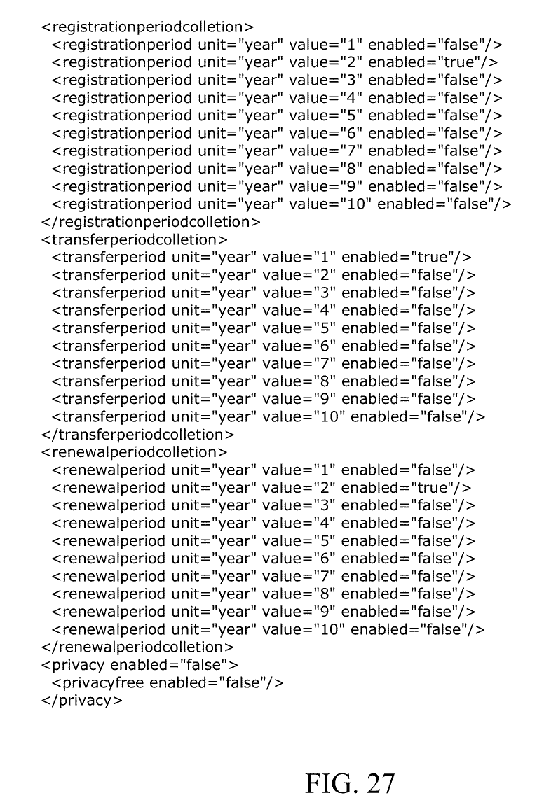

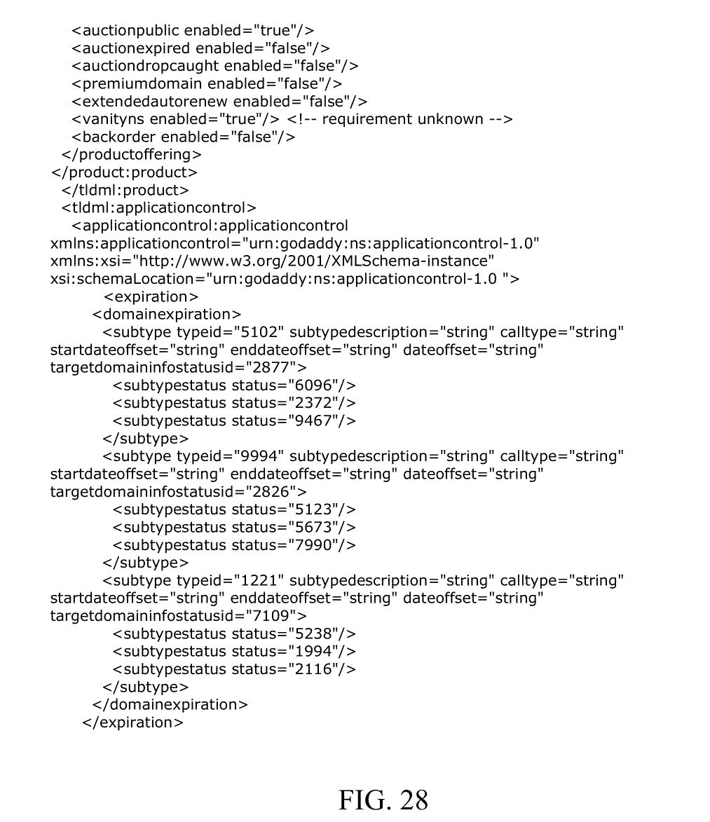

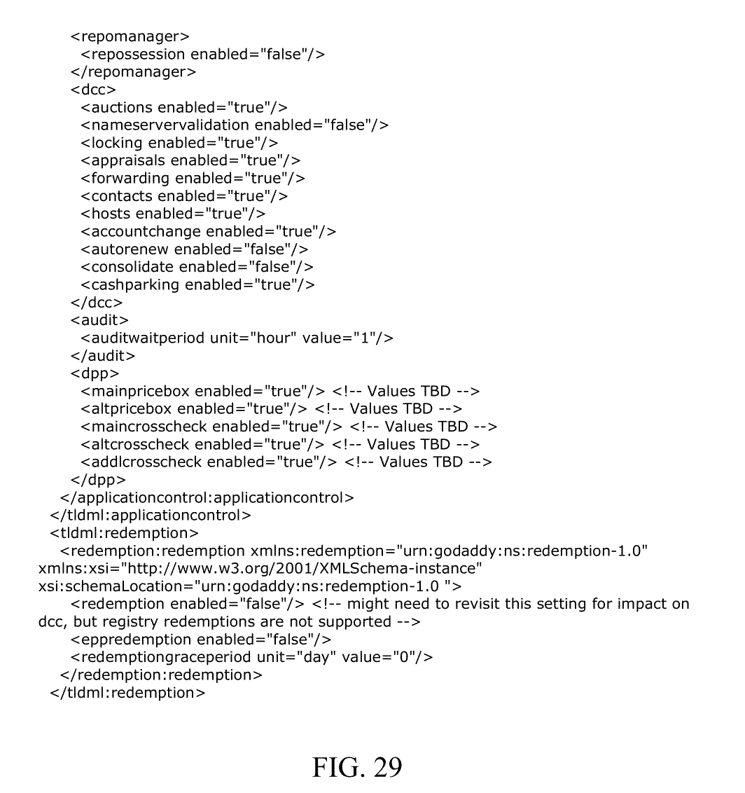

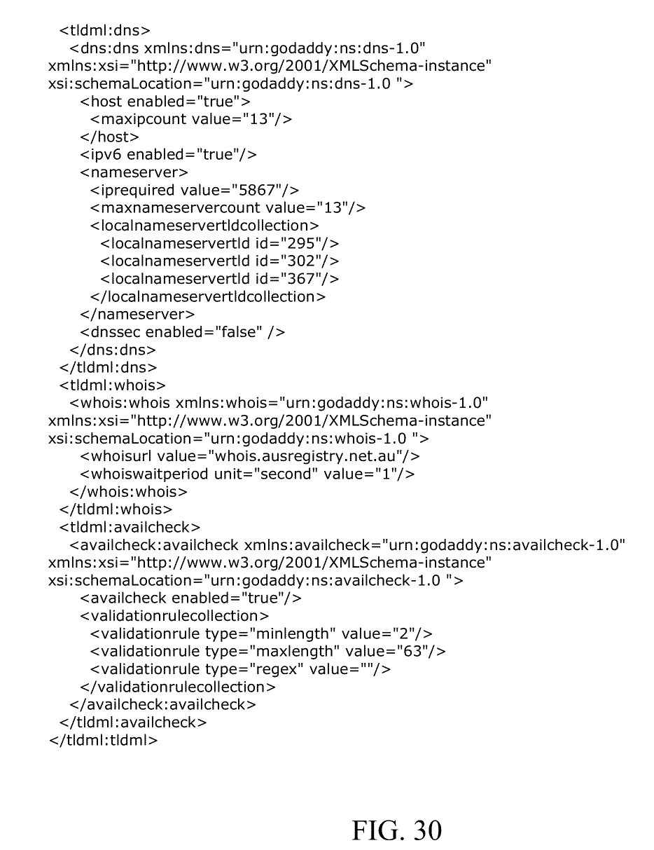

FIG. 23 is an example of an electronic document, an extended markup language document, a TLDML document and a TLDML XML document storing the business requirements for a specific TLD. The illustrated electronic document could be stored in a database 101 and used by a Registrar 100 to configure (or reconfigure) the Registrar's various functions.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

While the business requirements for a TLD have been described as stored in a TLDML XML document, TLDML document, extended markup language document, electronic document, file, record or data in a database in various embodiments (and are generally preferred in that order), it should be noted that the methods are interchangeable and each described embodiment in this specification should be considered as teaching all of these formats and languages of storing business requirements for TLDs. Further, a Registrar 100 has been used in many embodiments, but it should be noted that any domain name registering entity may be used in place of the Registrar 100 used in the described embodiments within this specification.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method, comprising the steps of:
a) storing an electronic document written in a structured markup language in a database, wherein the electronic document describes a plurality of Top-level Domain (TLD) business requirements for a TLD;
b) a first software routine receiving a first one or more of the plurality of business requirements from the electronic document; and
c) the first software routine programmatically configuring a first function within a domain name registering entity to permit the domain name registering entity to register a plurality of domain names having the TLD.

2. The method of claim 1, wherein the database is a distributed database.

3. The method of claim 1, wherein the electronic document stores the plurality of TLD business requirements for one, and only one, TLD.

4. The method of claim 1, wherein the plurality of business requirements for the TLD comprise a valid domain name registration period.

5. The method of claim 1, further comprising the step of:
d) receiving the plurality of business requirements for the TLD from a user interface on a webpage.

6. The method of claim 1, further comprising the step of:
d) receiving the plurality of business requirements for the TLD from an API.

7. The method of claim 1, further comprising the steps of:
d) updating the electronic document; and
e) programmatically reconfiguring the first function within the domain name registering entity based on the updated electronic document.

8. The method of claim 1, further comprising the step of:
d) storing a plurality of electronic documents in the database, wherein each electronic document, in the plurality of electronic documents, stores a plurality of TLD business requirements for one, and only one, TLD and no two electronic documents contain business requirements for the same TLD.

9. The method of claim 8, further comprising the steps of:
e) using a user interface to view and edit one of the plurality of electronic documents in the database; and
f) storing the viewed and edited electronic document back into the database.

10. The method of claim 1, further comprising the steps of:
d) a second software routine receiving a second one or more of the plurality of business requirements from the electronic document; and
e) the second software routine programmatically configuring a second function within a domain name registering entity to permit the domain name registering entity to register the plurality of domain names having the TLD.

11. The method of claim 1, wherein the electronic document is in the format of an extensible markup language.

12. A method, comprising the steps of:
a) storing an electronic document written in a structured markup language in a database of a domain name registering entity, wherein the electronic document describes a plurality of Top-level Domain (TLD) business requirements for a TLD;
b) a first function within the domain name registering entity reading the electronic document from the database;
c) the first function parsing the electronic document for one or more of the plurality of TLD business requirements; and
d) the first function programmatically configuring a first part of the domain name registering entity to permit the domain name registering entity to register a plurality of domain names having the TLD.

13. The method of claim 12, wherein the database is a distributed database.

14. The method of claim 12, wherein the electronic document stores the plurality of TLD business requirements for one, and only one, TLD.

15. The method of claim 12, wherein the plurality of business requirements for the TLD comprise a valid domain name registration period.

16. The method of claim 12, further comprising the step of:
e) receiving the plurality of business requirements for the TLD from a user interface on a webpage.

17. The method of claim 12, further comprising the step of:
e) receiving the plurality of business requirements for the TLD from an API.

18. The method of claim 12, further comprising the steps of:
e) a second function within the domain name registering entity reading the electronic document from the database;
f) the second function parsing the electronic document for one or more of the plurality of TLD business requirements; and
g) the second function programmatically configuring a second part of the domain name registering entity to permit the domain name registering entity to register the plurality of domain names having the TLD.

19. The method of claim 12, further comprising the step of:
e) storing a plurality of electronic documents in the database, wherein each electronic document, in the plurality of electronic documents, stores a plurality of TLD business requirements for one, and only one, TLD and no two electronic documents contain business requirements for the same TLD.

20. The method of claim 19, further comprising the steps of:
f) creating a computer interface to enable a user to view and edit a first electronic document in the plurality of electronic documents in the database; and
g) storing the viewed and edited first electronic document back into the database.

21. A method, comprising the steps of:
a) providing a computer interface that permits a Top-level Domain (TLD) to be selected from a plurality of TLDs;
b) receiving a plurality of structured markup language fragments for the TLD from a plurality of functions within a domain name registering entity;
c) combining the plurality of structured markup language fragments into an electronic document; and
d) displaying the electronic document on the computer interface.

22. The method of claim 21, wherein the electronic document stores a plurality of TLD business requirements for one, and only one, TLD.

23. The method of claim 22, wherein the plurality of business requirements for the TLD comprise a valid domain name registration period.

24. The method of claim 21, wherein the electronic document is in the format of a Top-level Domain Markup Language.
